(19) United States
(12) Patent Application Publication
(10) Pub. No.: US 2026/0181691 A1
(43) Pub. Date: Jun. 25, 2026

(54) TWO-WAY RF DATA COMMUNICATION

(71) Applicant: Nordic Semiconductor ASA, Trondheim (NO)

(72) Inventors: Martin TVERDAL, Trondheim (NO); Ruben UNDHEIM, Trondheim (NO); Omkar KULKARNI, Trondheim (NO)

(73) Assignee: Nordic Semiconductor ASA, Trondheim (NO)

(21) Appl. No.: 19/423,769

(22) Filed: Dec. 17, 2025

(30) Foreign Application Priority Data
Dec. 20, 2024 (GB) 2418907.8

(51) Int. Cl. H04W 74/0816; H04W 8/18; H04W 76/20

(52) U.S. Cl. CPC H04W 74/0816; H04W 8/183; H04W 76/20

(57) ABSTRACT

A method of operating a radio device which is configured, when receiving, to listen for radio packets sequentially on a plurality of radio channels according to a first sequence of the plurality of radio channels and, when transmitting, to transmit radio packets sequentially on the plurality of radio channels according to a second sequence of the plurality of radio channels. The method comprises the radio device, at a first time, listening on a first radio channel of the plurality of radio channels. When the device is listening on the first radio channel, it switches from receiving to transmitting. At a second time, it begins to transmit radio packets on the first radio channel. The device continues to transmit radio packets in the transmitting mode according to the second sequence by sequentially transmitting on the radio channels of the second sequence following the first radio channel.

### CROSS-REFERENCE TO RELATED APPLICATIONS

This application claims priority from United Kingdom Patent Application No. 2418907.8, filed Dec. 20, 2024, which application is incorporated herein by reference in its entirety.

This invention relates to switching between receiving and transmitting modes of a radio device.

### BACKGROUND OF THE INVENTION

Radio devices communicate wirelessly by exchanging radio packets. Typically, radio packets are exchanged after a pair of radio devices have established a dedicated connection. This might be done, for example, by one device sending a request packet and the second device replying with an acknowledgement packet to confirm the connection. Once the dedicated connection is formed, the radio devices may communicate by transmitting and receiving radio packets according to a predefined schedule.

In Bluetooth™ enabled radio devices, it is not always necessary for dedicated connections to be established before data is sent between devices. Instead, Bluetooth radios can communicate in an ad-hoc manner by operating in an advertising mode or a scanning mode, and switching between these modes as necessary. In the advertising (i.e. transmitting) mode, the device transmits radio packets on a specific set of radio channels according to a specific sequence. The advertising packets are not intended for any one radio device, rather they are sent out for receipt by any radio device that is in range and is listening on the right radio channel.

In the scanning (i.e. receiving) mode, the radio device listens on a set sequence of radio channels for incoming advertising packets. When it is scanning on a radio channel that a particular advertising packet was transmitted on, the radio device can receive that packet and then act accordingly—e.g. by acting on the data received (in the case that the data represents an instruction), initiating a dedicated connection, or going to a different channel indicated in the advertisement in order to receive more data.

Since radio packets are being transmitted on a sequence of radio channels, it is advantageous for radio devices to be in the scanning mode as much as possible, particularly when the radio devices form a mesh network. Scanning as often as possible increases the likelihood of intercepting incoming radio packets.

When a radio device switches from the scanning mode to the advertising mode, and vice versa, there is an associated period of time where the radio device is neither listening for or sending out radio packets. The length of this downtime negatively affects how long a radio device can be scanning for packets, and therefore negatively affects the percentage uptime of the radio device. The total loss of time is multiplied when considering a plurality of radio devices that comprise a mesh network.

The invention seeks to mitigate these shortcomings.

### SUMMARY OF THE INVENTION

From a first aspect, the invention provides a method of operating a radio device, wherein the radio device is configured:
in a receiving mode, to listen for radio packets sequentially on a plurality of radio channels according to a first sequence of the plurality of radio channels;
in a transmitting mode, to transmit radio packets sequentially on the plurality of radio channels according to a second sequence of the plurality of radio channels;
wherein the method comprises the radio device:
at a first time, listening in the receiving mode on a first radio channel of the plurality of radio channels;
when listening on the first radio channel, switching from the receiving mode to the transmitting mode;
at a second time, beginning to transmit radio packets on the first radio channel; and
continuing to transmit radio packets in the transmitting mode according to the second sequence by sequentially transmitting on the radio channels of the second sequence following the first radio channel.

From a second aspect, the invention provides a radio device, comprising receiver circuitry and transmitter circuitry, wherein the radio device is configured:
in a receiving mode, to listen for radio packets using the receiver circuitry sequentially on a plurality of radio channels according to a first sequence of the plurality of radio channels;
in a transmitting mode, to transmit radio packets using the transmitter circuitry sequentially on the plurality of radio channels according to a second sequence of the plurality of radio channels;
wherein the radio device is further configured:
at a first time, to listen in the receiving mode on a first radio channel of the plurality of radio channels;
when listening on the first radio channel, to switch from the receiving mode to the transmitting mode;
at a second time, to begin to transmit radio packets on the first radio channel; and
to continue to transmit radio packets in the transmitting mode according to the second sequence by sequentially transmitting on the radio channels of the second sequence following the first radio channel.
Thus it will be seen that, in accordance with the invention, by operating the radio device to transmit on the same radio channel on which it was previously listening, the amount of time taken to switch between the receiving mode and the transmitting modes (e.g. from a scanning mode to an advertising mode) is decreased. This is because the radio device only has to change from the receiving mode to the transmitting mode, rather than also spending time switching to use a different radio channel. This reduces the duration of the downtime associated with the switchover from the receiving mode to the transmitting mode where the radio device is neither listening for nor transmitting radio packets. This may advantageously allow for the radio device to extend how long it can remain in the receiving mode before it switches to the transmitting mode, thereby increasing the length of time that the radio device is available to receive radio packets. As a result, the total utilisation of a radio device employing the invention can be increased. Such a radio device is more likely to pick up transmitted radio packets, thereby reducing the average latency of the radio device.

The approach set out above contrasts with the conventional one in which the transmission and listening operations are treated as independent of one another so that scanning resumes at the point in the sequence it had got to. It will be appreciated that it will sometimes occur in such arrangements that the channel on which listening resumes happens to be that on which transmission was previously taking place, but this is typically not predictable and is different from ensuring that the listening channel is the same as the transmission one, regardless of where the listening sequence left off.

The Applicant has recognised that as well as keeping the same channel being used for listening when switching to transmission, returning to the receiving mode on the same radio channel on which the radio device was transmitting may also create a time saving when the radio device switches from the transmitting mode to the receiving mode. Therefore, in a set of embodiments, the radio device:
at a third time, transmits on a second radio channel of the plurality of radio channels;
when transmitting on the second radio channel, switches from the transmitting mode to the receiving mode;
begins to operate in the receiving mode at a fourth time on the second radio channel; and
continues to listen for radio packets in the receiving mode according to the first sequence by sequentially listening on the radio channels of the first sequence following the second radio channel.

Typically, the first sequence is the same as the second sequence. Thus, when the radio device is operating in either the receiving mode or the transmitting mode, it operates according to the same sequence of radio channels. However this is not essential—for example the second sequence could be in the reverse order compared to the first sequence.

The radio device may operate according to a Bluetooth protocol. For example, the radio device may be a Bluetooth Low Energy (BLE) device.

In some embodiments where the radio device operates according to a Bluetooth protocol, the radio packets transmitted in the transmitting mode are advertising packets. The advertising packets may be sent out periodically on the plurality of radio channels at set intervals. However this is not essential.

In a set of embodiments, at least some of the radio packets transmitted in the transmitting mode are pointer packets which point to payload radio channels. The payload radio channels may not be part of the first or second sequence of radio channels. This allows more data to be transmitted on the payload radio channels without clogging up the advertising channels. Therefore, when a radio device receives a pointer, it can be instructed to scan on the radio channel indicated by the pointer to receive the full payload. As will be understood by those skilled in the art, this arrangement may advantageously provide improved bandwidth in radio environments where the radio channels of the first and second sequence are congested, allowing for the full radio payload to be transmitted on a less busy channel.

In a set of embodiments, the radio device is configured:
to continue to transmit a plurality of radio packets in the transmitting mode according to the second sequence by sequentially transmitting on the radio channels of the second sequence following the first radio channel, prior to reverting to the receiving mode.

In a set of embodiments, the radio device is configured:
to continue to listen for a plurality of radio packets in the receiving mode according to the first sequence by sequentially listening on the radio channels of the first sequence following the second radio channel, prior to reverting to the transmitting mode.

In a set of embodiments, the plurality of radio channels comprises radio channels 37, 38, and 39. As will be understood by the skilled person, in a set of embodiments, channels 37, 38, and 39 correspond to frequencies of 2402 MHz, 2426 MHz, and 2480 MHz respectively. These are the radio channels specified in Bluetooth Low Energy (BLE) standards, and can be used by BLE radio devices to transmit radio packets in the transmitting mode to other devices without an established connection.

In a set of embodiments, the radio device transmits on a subsequence of the second sequence while in the transmitting mode. The subsequence may comprise one or more of the radio channels in the second sequence, but not all. The radio device may transmit on the subsequence as a result of local radio conditions (e.g. one of the channels being affected by interference).

In a set of embodiments, the radio device repeats the second sequence when in the transmitting mode by cycling through the radio channels of the second sequence for a set number of times. Thus, the radio device may transmit radio packets on the plurality of radio channels of the second sequence multiple times. This helps to increase the chance of another radio device scanning on the right radio channel and receiving the transmitted packets.

In a set of embodiments, listening on the first radio channel at the first time has a longer duration than transmitting on the first radio channel at the second time. This helps to ensure that advertising packets are received without excessive delay.

In a set of embodiments, the identity of the first radio channel is stored before switching modes. The identity of the first radio channel can then be read by the radio device when switching from the receiving mode to the transmitting mode. This facilitates the radio device beginning the second sequence of the transmitting mode on the first radio channel.

In a set of embodiments, the radio device switches between the receiving mode and the transmitting mode at set intervals of time. The radio device may comprise a timer for this purpose.

In a set of embodiments, the radio device determines the local radio traffic conditions, and based on the determined local radio traffic conditions, switches from the receiving mode to the transmitting mode.

The radio device may be part of a mesh network, such as a BLE mesh network. When the radio device is in a mesh network, the time saved by switching between the receiving mode and the transmitting mode (and vice versa) can be multiplied when data is propagated across the mesh network. Thus, the latency of propagating data across the network can be significantly reduced.

In a set of embodiments, the radio device switches from the receiving mode to the transmitting mode based on a received radio packet. When the radio device is part of a mesh network, the radio device may switch to the transmitting mode to relay the received radio packet to other devices in the network.

From a third aspect, the invention provides a non-transitory computer readable storage medium comprising instructions which, when executed, cause a radio device to carry out the method according to embodiments of the first aspect described herein.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram of a wireless mesh network comprising radio devices that embody the present invention;

FIG. 2 is a timing diagram illustrating a radio device switching between receiving and transmitting modes according a conventional implementation;

FIG. 3 is a timing diagram illustrating a radio device switching between receiving and transmitting modes according to an embodiment of the present invention;

FIG. 4 is a timewise comparison of a radio device switching from a receiving mode to a transmitting mode and back according to the conventional implementation, and a radio device switching from a receiving mode to a transmitting mode and back according to an embodiment of the present invention;

FIG. 5 is a timing diagram showing the interaction between a pair of radio device operating according to a conventional implementation where one radio device is in a receiving mode, and the other radio device switches from a receiving mode to a transmitting mode and back;

FIG. 6 is a timing diagram showing the interaction between a pair of radio devices operating according to embodiments of the present invention, where one radio device is in a receiving mode, and the other radio device switches between a receiving and transmitting mode; and

FIG. 7 is a flowchart illustrating a method in accordance with the present invention.

### DETAILED DESCRIPTION OF THE INVENTION

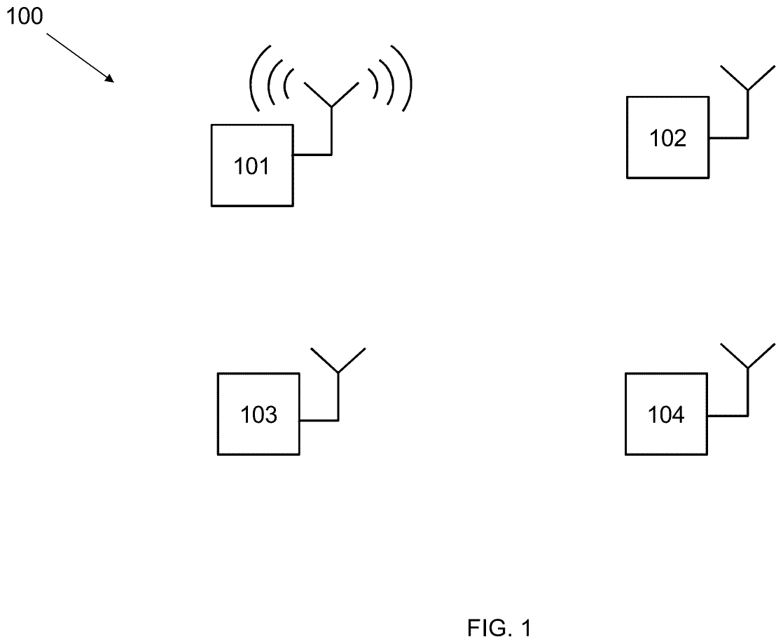

FIG. 1 shows an example radio network 100 comprising four radio devices 101, 102, 103, 104. The radio devices 101-104 are each equipped with receiving circuitry and transmitting circuitry, in order to enable the radio devices 101-104 to transmit and receive radio frequency (RF) data packets. It will be appreciated that the transmitting and receiving circuitry will typically comprise mixers, filters, digital-to-analog converters, analog-to-digital converters, etc. as needed. The radio devices 101-104 are also equipped with other components, such as power sources, processors, memory, etc. as required by the particular use case of the radio devices 101-104. The number of radio device shown in FIG. 1 is merely illustrative, and any number of radio devices could be used in practice. In FIG. 1, the radio devices 102, 103, and 104 are all in a receiving (scanning) mode, and radio device 101 is in a transmitting (advertising) mode.

Unlike in other radio protocols, where a dedicated connection is established and radio packets are exchanged according to a schedule, Bluetooth Low Energy (BLE) radio devices can communicate in an ad-hoc manner. This is achieved by some radio devices sending advertising packets in the advertising mode, and other radio devices scanning for advertising packets in the scanning mode. Advertising and scanning are often performed on a sequence of radio channels. Both the receiving (scanning) mode and the transmitting (advertising) mode typically follow the same sequence of radio channels during operation.

The radio channels of the sequence are not necessarily neighbours in frequency in order avoid adjacent channel interference. Nevertheless, the radio channels of the sequence are often given consecutive labels. For example, in Bluetooth Low Energy (BLE) protocols, primary advertising channels 37, 38, and 39 are reserved for advertising and scanning. The sequence of radio channels followed is sequential—i.e. channel 37, then 38, and then 39, which may be repeated as many times as necessary while the radio device is in either the scanning or advertising mode. As will be appreciated, other radio standards or other features of BLE protocols may use other radio channels for the sequence according to the specific requirements of the standard. The following discussion will refer to radio channels 37, 38, and 39 as being the radio channels that comprise the sequence.

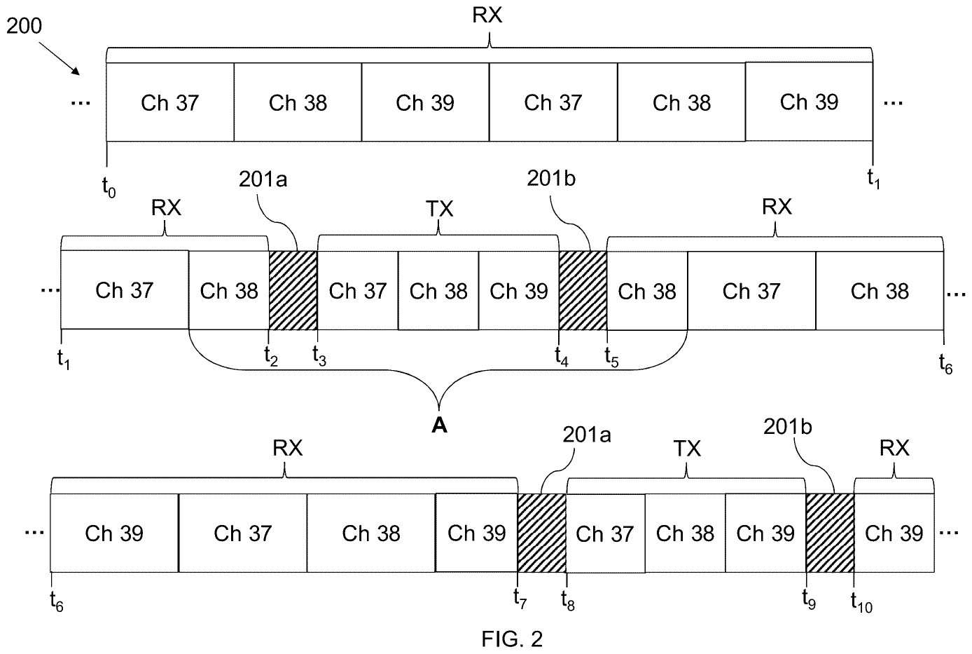

FIG. 2 is a timing diagram 200 showing how a generic BLE radio device switches between scanning and advertising modes according to a conventional implementation. The timing diagram will be described with reference to the radio channels of the sequence of radio channels mentioned above (i.e. radio channels 37, 38, and 39).

When another radio device is advertising, it transmits advertising packets on radio channels according to the cycle of radio channels-i.e. on channel 37 first, then 38, then 39. The radio device illustrated in FIG. 2 scans (listens) for these packets on one channel of the sequence of radio channels at a time. For example, the radio device will scan on channel 37 first for a period of time, then channel 38, and finally channel 39 before repeating the sequence for as long as the radio device 102 remains in the scanning mode. This is shown in the RX section of FIG. 2. The duration of the channel scanning window (how long a radio device is scanning on a particular channel) might, for example, be approximately 18 milliseconds. When a radio device is scanning on a specific channel (e.g. channel 38), it will be able to receive the advertising packet which was transmitted by another radio device on that same channel. Advertising packets transmitted on the other radio channels of the sequence (e.g. channels 37 and 39) will not be received.

At some point during operation, the BLE radio device switches from the scanning mode to the advertising mode - illustrated as the TX section of FIG. 2. This may happen because the radio device is part of a mesh network, and needs to advertise its presence to any other radio devices in range, or needs to transmit a specific packet to any radio devices in range. The radio device may switch modes at random, as a result of radio traffic conditions, at set times predetermined for the radio device or in response to an event. Such an event could be something occurring in a device of which the radio device forms part - e.g. if the radio device is installed in a smoke detector, and is in the scanning mode, a triggered smoke alarm may cause the radio device to switch from scanning to transmitting. In other examples the event could be receipt of a radio packet which needs to be relayed to any other radio devices in range when the radio device is part of a mesh network.

In order to switch between scanning and advertising, the radio device powers down the transmitting or receiving circuitry, and powers up the other of the transmitting or receiving circuitry. For example, if the radio device is switching from the scanning mode to the advertising mode, it must power down its receiving circuitry, and subsequently power up its transmitting circuitry. During this switching process, there is a period of time 201a where the radio device is neither scanning or advertising.

More specifically, the timing diagram 200 begins at a time t₀ where the radio device is operating in scanning mode (indicated as RX in FIG. 2) on radio channel 37. Operation in scanning mode continues according to the sequence of radio channels up to a time t₁. At the time t₁, the radio device remains in scanning mode up to the end of channel 38 at a time t₂. At the time t₂, the radio device is interrupted during scanning on channel 38 and begins to switch from scanning mode to advertising mode (indicated as TX in FIG. 2). The switch from scanning to advertising may have been triggered by any of the reasons stated above. The time taken to switch from scanning to advertising (the RX-TX transition time) is shown by the first dashed portion 201a, and lasts from the time t₂ up to a time t₃ at the start of the advertising mode. During the RX-TX transition time 201a, the radio device is switching power states of the transmitting and receiving circuitry and is unable to receive or transmit radio packets. In the example of FIG. 2, the duration of the RX-TX transition time 201 a is approximately 20 microseconds, though it will be appreciated that this time period is dependent on the radio hardware in use.

Once the radio device is in the advertising mode starting at the time t₃, the radio device begins to transmit radio packets on channel 37, according to the sequence of radio channels. Although the advertising windows for each channel are shown schematically in the diagram as being of the same duration as the scanning windows, in practice they are typically much shorter. For example, the scanning windows may be approximately 18 milliseconds for each frequency, whereas the duration of the advertising event may be around only 400 microseconds for each frequency.

In the conventional implementation, the radio device will always start the advertising mode on channel 37. In the example shown in FIG. 2, the radio device only advertises for a single cycle of the sequence, ending with channel 39. After transmission on channel 39 is complete, at a time t₄, the radio device begins to switch back to scanning. The time taken to switch from advertising to scanning (the TX-RX transition time) is indicated by the dashed portion 201b, and lasts from the end of channel 39 at the time t₄ up to a time t₅ at the start of channel 38 in the scanning mode. As with the RX-TX transition time 201a, during the TX-RX transition time 201b, the radio device is unable to receive or transmit radio packets. The two transition times 201a, 201b are often of a similar duration. Thus, the total time taken to switch from scanning to advertising and back again is approximately 40 microseconds in the example of FIG. 2.

When the radio device has switched back to scanning, starting at the time t₅ on channel 38 (and staying on channel 38 for the remainder of the scanning window which was interrupted at the time t₂), it continues to operate in the scanning mode according to the sequence of radio channels (i.e. moving on to channel 39, and then starting the sequence again at channel 37) up to a time t₆. The radio device resumes scanning on channel 38 at the time t₅ because this was the radio channel used by the radio device when it was last in the scanning mode at time t₂.

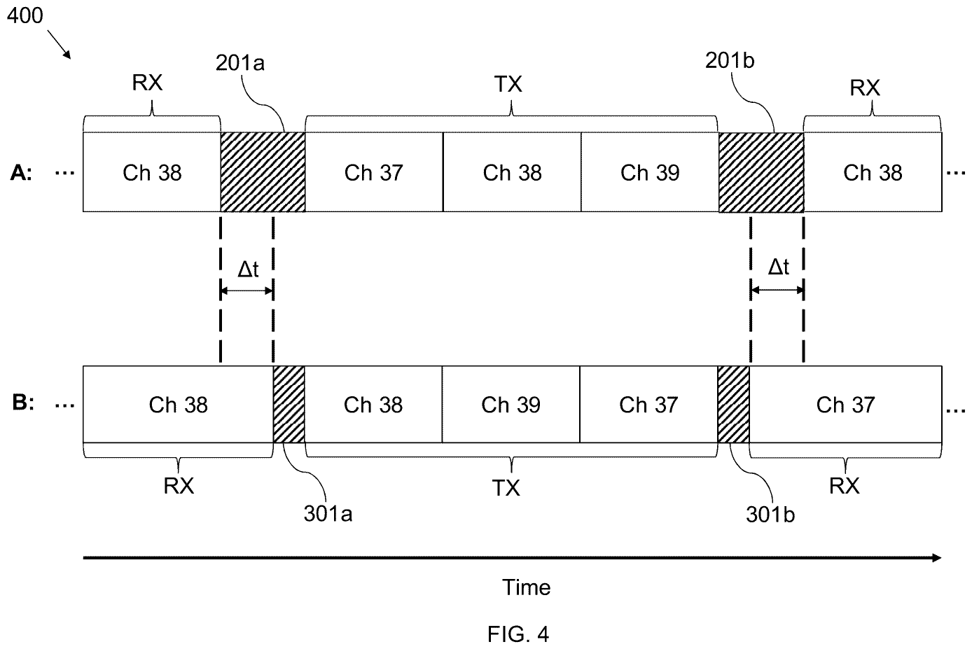

The region of the timing diagram 200 marked with the label A contains the part of the timing diagram 200 from the beginning of the last scanning channel before the time t₂ up to the end of the first scanning channel after the time t₅. This portion will be discussed in more detail in relation to FIG. 4.

After the time t₆, the radio device remains in the scanning mode up to a time t₇ when the device is again interrupted during scanning and begins to switch back to the advertising mode. FIG. 2 thus shows the radio device switching over to the advertising mode for a second time. On this occasion, the scanning mode is on channel 39 at the time t₇, and the RX-TX transition period 201a lasts from the time t₇ until a time t₈ where the advertising mode begins again. At the time t₈, as with the previous mode switch, the advertising mode beings on channel 37, and continues for a single cycle of the radio channel sequence up to a time t₉. The time t₉ marks the start of the TX-RX transition time 201b, which ends at the time t₁₀ where the radio device resumes operation in the scanning mode on channel 39 (and stays on channel 39 for the remainder of the scanning window which was stopped at time t₇). Channel 39 is used at the time t₁₀ because this was the last radio channel that the radio device was scanning on before the transition to the advertising mode that began at the time t₇.

It can be seen then that in this conventional implementation, the radio device always starts advertising by transmitting radio packets on the first radio channel of the sequence—in this example channel 37. When switching back to scanning, the radio device resumes receiving on the radio channel of the sequence on which it was last scanning. A conventional implementation therefore treats the receiving mode and the transmitting mode independently from one another with respect to which radio channels are in use.

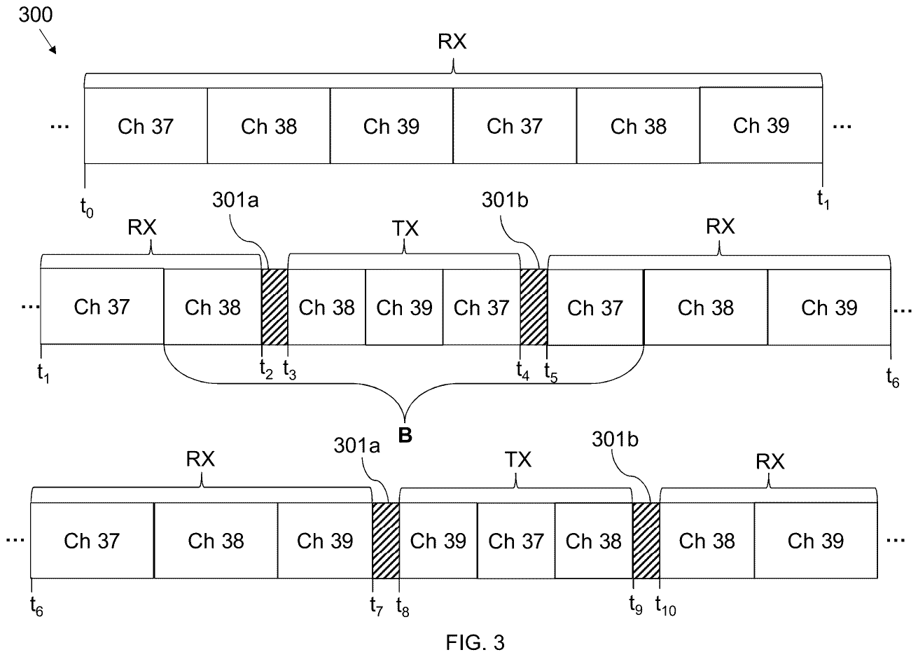

FIG. 3 is a timing diagram 300 showing how one of the radio devices 102 shown in FIG. 1 switches between scanning and advertising in accordance with the present invention. As with FIG. 2, the timing diagram of FIG. 3 will be described in relation to radio channels 37, 38, and 39.

Similarly to FIG. 2, the radio device 102 is first depicted as being in the scanning mode at a time t₀, and follows the sequence of radio channels up to a time t₁. After the time t₁, the radio device 102 scans on channel 37, and then channel 38 (per the radio channel sequence), but is then required to switch over to the advertising mode. The time taken for the radio device 102 to switch from scanning to advertising (the RX-TX transition time) is indicated by the dashed portion 301a. The RX-TX transition time 301a lasts from the interruption of scanning on channel 38 at a time t₂ to a time t₃ marking the beginning of the advertising mode. During the RX-TX transition time 301a, the radio device 102 is unable to receive or transmit radio packets for the same reason given above.

After the switch to the advertising mode is complete, the radio device 102 starts advertising on the same radio channel on which it was previously scanning at the time t₃. In the example shown in FIG. 3, this is channel 38. The radio device 102 therefore changes from scanning to receiving, but does not change the radio channel on which it is operating. By continuing to operate at the same frequency the time taken to switch from RX to TX can be reduced significantly as a very small or no adjustment period is necessary for the RF hardware. For example, a given radio may be able to switch in approximately 10 microseconds compared to 20 microseconds where a different frequency is also being employed.

The radio device 102 then transmits advertising radio packets according to the sequence of radio channels for a single cycle of the sequence. Again, the transmission windows are shown schematically as a similar length to the reception ones but are typically much shorter. Of course, it will be appreciated that multiple cycles of the sequence may be implemented during the advertising mode as necessary. Conversely, only a portion of the sequence may be implemented during the advertising mode. For example, when in the advertising mode, the radio device 102 may transmit on channels 38 and 39, but not channel 37, or any other combination. This may be due to local radio conditions, which results in a particular channel being particularly noisy or congested.

Since advertising began on channel 38 at the time t₃, the advertising mode follows the radio channel sequence until channel 37, such that a full sequence of radio channels is still completed. The radio device 102 then begins to switch from advertising to scanning at the end of channel 37, marked by a time t₄. The time taken to switch from advertising to scanning (the TX-RX transition time) is indicated by the dashed portion 301b, and lasts from the time t₄ to a time t₅ when the radio device 102 resumes scanning. The duration of the TX-RX transition time 301b in this example embodiment is approximately 10 microseconds, though this value is dependent on the kind of radio hardware in use. The duration of the RX-TX transition time 301a in this example embodiment is also approximately 10 microseconds, though again this value is dependent on the kind of radio hardware in use.

While in the advertising mode following the sequence, the radio device 102 transmits packets which contain pointers to a payload radio channel. The pointer packet is quite short to ensure it is received in busy radio conditions. When such a pointer packet is received by another radio device, e.g. the radio device 103, the receiving radio device 103 is instructed to scan on the payload channel indicated by the pointer. The transmitting radio device 102 can then transmit the full radio payload on the payload channel. The payload radio channel is not necessarily part of the sequence of radio channels, since these channels could become congested from high traffic. This allows for the radio device 102 to take advantage of quieter radio channels to ensure that the full payload is more likely to be received.

In the example embodiment of the invention shown in FIG. 3, the total time taken to switch from scanning to advertising, and then back to scanning again is approximately 20 microseconds. As mentioned above, different radio hardware will take different lengths of time to switch between modes, and so this total downtime for the radio device 102 will vary depending on the specific circumstances.

Once the radio device 102 has switched back to scanning at the time t₅, the radio device continues to scan on channel 37, as this was the last radio channel that the device 102 was advertising on. The duration of this first scanning channel after switching back to receiving will last for the remainder of the duration of the scanning window which was interrupted at the time t₂. Subsequently, the radio device 102 operates in the scanning mode following the sequence up to time t₆.

The region of the timing diagram 300 marked with the label B contains the section of timing diagram 300 from the beginning of the last scanning radio channel before the time t₂ up to the end of the first scanning radio channel after the time t₅. The region B will be described in more detail in relation to FIG. 4.

After the time t₆, the radio device 102 remains in the scanning mode until channel 39 where it is interrupted and begins to switch from scanning to advertising once again. In this instance, the RX-TX transition time 301a begins at a time t₇, and ends at a time t₈ when the radio device 102 begins advertising on channel 39. The radio device 102 begins advertising on channel 39 because this was the last radio channel that the device 102 was scanning on. In the same way as the previous mode switch shown in FIG. 3, the radio device 102 changes which mode it operates on, but does not change the radio channel. To ensure a full sequence of radio channels is used in the advertising mode, radio channels 37 and 38 are used in that order to complete the sequence.

The end of channel 38 is marked by a time t₉, which also marks the start of the TX-RX transition time 301b. The TX-RX transition time 301b ends at a time t₁₀, after which the radio device 102 has switched back to the scanning mode, and resumes scanning on channel 38, as this was the last channel in use for the advertising mode, and for the length of time left over from the scanning window interrupted at the time t₇. After the time t₁₀, the radio device 102 will continue to scan until it is required for the radio device 102 to switch modes once more, but this has been omitted from FIG. 3 for clarity.

By preserving the current radio channel after switching between scanning and advertising modes (and vice versa), the transition times 301a, 301b are reduced in length compared to those of the conventional implementation shown in FIG. 2 (the transition times 201a, 201b). Consequently, the radio channel of the scanning mode either side of the mode switch is able to have an increased length compared to the conventional implementation. This will be described in more detail with reference to FIG. 4.

FIG. 4 is timewise comparison 400 of the region A (shown at the top of FIG. 4) of the timing diagram 200 from FIG. 2 with the region B (shown at the bottom of FIG. 4) of the timing diagram 300 from FIG. 3. FIG. 4 therefore compares how long it takes a radio device to switch modes according to a conventional approach and according to embodiments of the present invention. An arrow pointing left to right shows the direction of time.

As mentioned above, the durations of the two transition times 201a, 201b shown in FIG. 2 for the conventional approach are longer than those of the two transition times 301a, 301b shown in FIG. 3 for the example embodiment of the present invention. The difference in time, Δt, between the two approaches is indicated by the dotted lines in FIG. 4. This is because, for the conventional approach, the radio device switches not only between power states of the receiver circuitry and the transmitter circuitry, but also reconfigures to use a different radio channel. This additional step used by the conventional approach adds extra time to the transition between modes, and thereby reduces the amount of time that the radio device can be active for the same period of time compared to the embodiment of present invention.

By using embodiments of the invention, the amount of time used for the switch between modes is reduced by an amount Δt. Since it is preferable for the device to be scanning as much as possible in order to increase the chance of receiving an incoming radio packet, the associated time saving created by employing the invention can be used to extend the length of time that the device is in the scanning mode. As above, it may take a radio device operating with a conventional approach 20 microseconds to change modes (i.e. from scanning to advertising), whereas a radio device 102 following the present invention shown in FIG. 3 only takes 10 microseconds to perform the same task.

Implementing the invention may therefore save substantial time compared to conventional approaches. Considering that, in one example, the total time for a radio device 102 to switch to the advertising mode, transmit its advertising packets according to the sequence, and then switch back to the scanning mode lasts approximately 400 microseconds, the percentage time saving by implementing the invention could be around 5 percent.

FIG. 4 only shows the time saving for one specific radio device 102 implementing the invention, but when a whole radio network is considered (e.g. a BLE mesh network), the time saving for a typical transmission, which may traverse many nodes in reaching its ultimate destination, a considerable percentage decrease in the average latency for such transmissions can be realised.

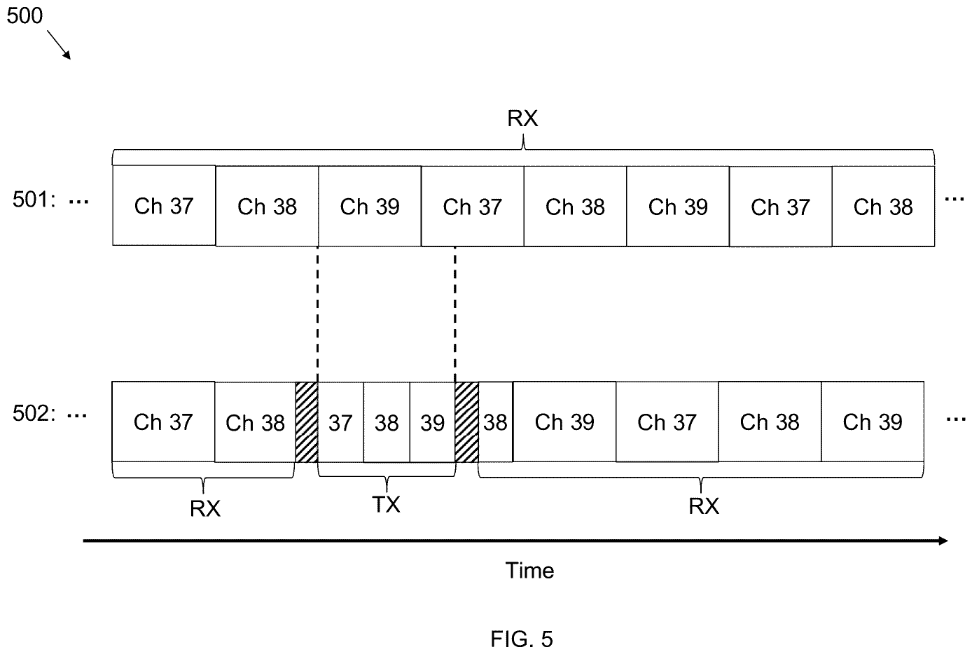

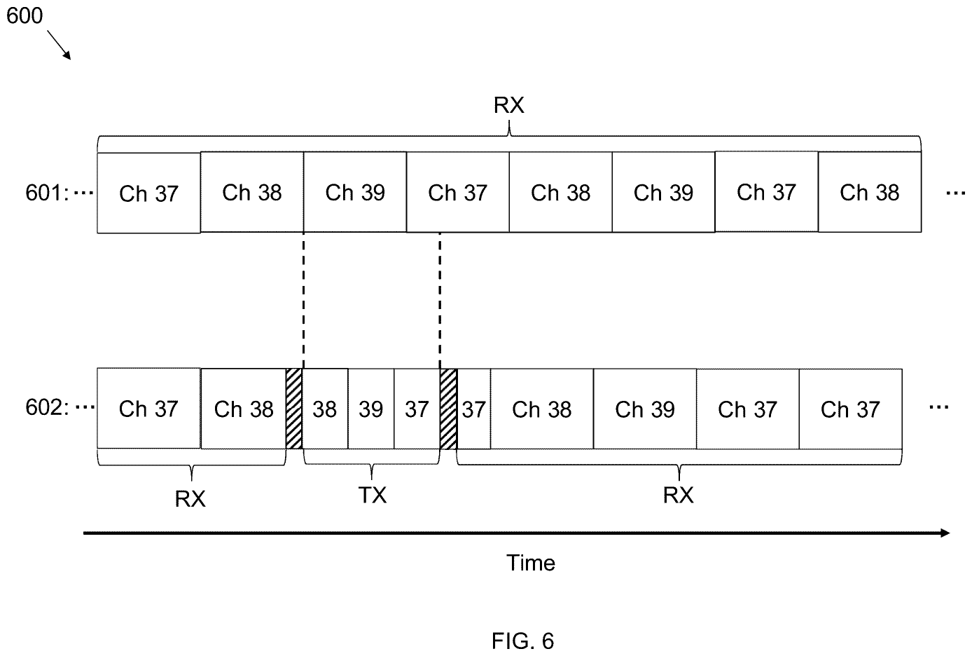

The benefits which can be achieved in accordance with the present invention can be understood further with reference to FIGS. 5 and 6 which show a pair of radio devices, with one of each pair switching modes according to a conventional implementation and an embodiment of the present invention respectively. Both FIGS. 5 and 6 show blocks representing scanning channels and advertising channels. The relative size of these channels in FIGS. 5 and 6 is not to scale, but merely illustrative.

FIG. 5 is a timing diagram 500 which shows at the top thereof a first radio device 501 operating in scanning mode in a sequence of radio channels; and operation of a second radio device 502 directly below. An arrow pointing left to right at the bottom of FIG. 5 shows the direction of time. The first and second radio devices operate according to the conventional implementation described above with reference to FIG. 2.

The first radio device 501 repeatedly cycles through listening on the sequence of channels without switching to advertising. Concurrently, the second radio device 502 is shown to be in the scanning mode initially on channel 37, followed by channel 38, but then switches over to the advertising mode after the scanning on channel 38 is interrupted. As described in relation to FIG. 2, after all three radio channels of the sequence have been transmitted on by the radio device, the second radio device 502 switches back to scanning on the same radio channel it was last scanning on (channel 38), and continues receiving until the devices switches again.

The dotted lines shown between the timing diagrams for the first and second radio devices 501, 502 show the overlap between the advertising mode of the second radio device 502 and the scanning mode of the first radio device 501. Considering the first radio device 501, because the second radio device 502 always advertises in the same order of radio channels, there is only one occasion where the first radio device 501 is scanning on the same radio channel that the second radio device 502 is advertising on, and even then the overlap between the correct channels is quite small. The first radio device 501, in this example, will only be able to receive some of the radio packets transmitted on channel 39 by the second radio device 502. This is because only a portion of the advertising on channel 39 is concurrent with the scanning on channel 39. For given radio conditions this reduces the likelihood of the advertising packet being successfully received and decoded.

FIG. 6 is a timing diagram 600 showing a first radio device 601 operating continually in the scanning mode, similarly to the first radio device 501 of FIG. 5. FIG. 6 also shows a second radio device 602 operating in accordance with the present invention. As in FIG. 5, the second radio device 602 switches to the advertising mode after being interrupted from scanning on channel 38, but since the second radio device 502 is following the invention, the advertising mode also starts on channel 38.

The dotted lines in FIG. 6 show the overlap between the scanning mode of the first radio device 601, and the advertising mode of the second radio device 602. Unlike the example in FIG. 5, because the invention allows the second radio device 602 to preserve the same radio channel after switching modes, more of the channels used for advertising align with portions of the radio channels used for scanning by the first radio device 601. In this example, all of advertising channel 39 aligns with scanning channel 39, and a portion of advertising channel 37 aligns with scanning channel 37. By using the invention, more of the advertising packets have the opportunity to be successfully received. Considering the example of FIG. 6 in the context of a mesh network, it can be seen that there would be an increase in average likelihood of advertising packets being successfully received across the whole network. This significantly reduces the average latency of a multi-hop transmission of the network at a whole.

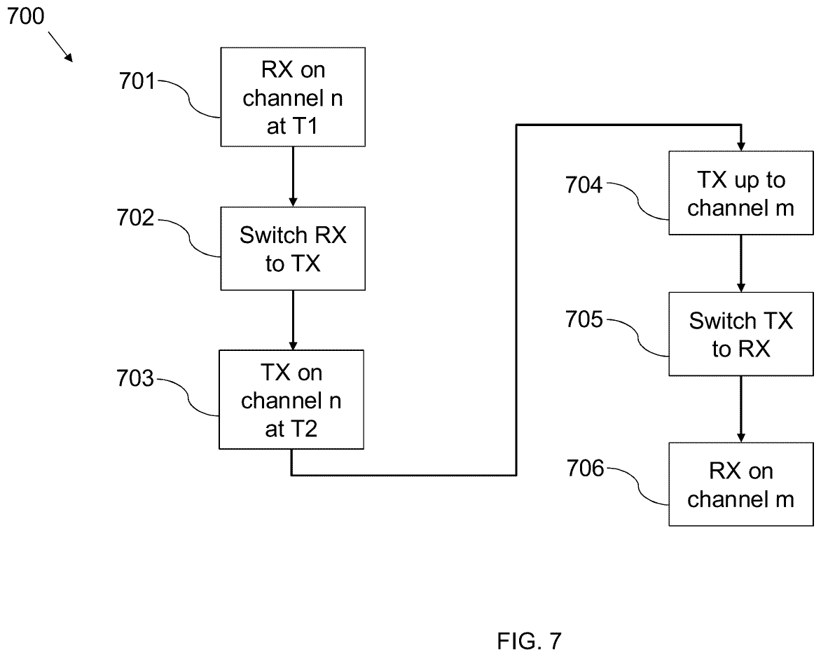

FIG. 7 shows a flowchart for carrying out an example method 700 of the present invention on a radio device (e.g. the radio device 102). The method 700 begins at step 701, where the radio device 102 is scanning on a channel n at a first time T1. Channel n could be any channel of the sequence of radio channels described above.

At step 702, the radio device 102 switches from the scanning mode to the advertising mode. As described above, this takes a period of time, during which the radio device 102 does not receive or transmit radio packets.

At step 703, the radio device 102 begins advertising on channel n at a second time T2. By advertising on the same radio channel n as before at the second time T2, the duration of the switch between scanning and advertising is reduced compared to conventional methods.

At step 704, the radio device 102 continues to advertise according to the sequence of radio channels following on from channel n up to a channel m. Channel m is the radio channel corresponding to the last channel in the sequence that comes after all the channels after channel n have been transmitted on, whilst ensuring that all channels of the sequence are accounted for. For example, if the sequence contains channels 37, 38, and 39, and channel n was channel 38, then channel m would be channel 37 (the transmission order would be 38, 39, 37).

At step 705, the radio device 102 switches from the advertising mode to the scanning mode. This step will come after the radio device 102 has completed transmitting advertising radio packets.

Finally, at step 706, the radio device 102 continues to scan on channel m. The radio device 102 may continue to scan on the radio channels of the sequence following channel m, and then follow the sequence for as many cycles as needed while the scanning mode is operational before the radio device 102 switches back to the advertising mode. At this point, the radio device 102 has returned to step 701, and the method 700 is repeated.

It will be appreciated by those skilled in the art that the invention has been illustrated by describing one or more specific embodiments thereof, but is not limited to these embodiments; many variations and modifications are possible, within the scope of the accompanying claims.

1. A radio device, comprising receiver circuitry and transmitter circuitry, wherein the radio device is configured:
in a receiving mode, to listen for radio packets using the receiver circuitry sequentially on a plurality of radio channels according to a first sequence of the plurality of radio channels;
in a transmitting mode, to transmit radio packets using the transmitter circuitry sequentially on the plurality of radio channels according to a second sequence of the plurality of radio channels;
wherein the radio device is further configured:
at a first time, to listen in the receiving mode on a first radio channel of the plurality of radio channels;
when listening on the first radio channel, to switch from the receiving mode to the transmitting mode;
at a second time, to begin to transmit radio packets on the first radio channel; and
to continue to transmit radio packets in the transmitting mode according to the second sequence by sequentially transmitting on the radio channels of the second sequence following the first radio channel.

2. The radio device of claim 1, wherein the first sequence is the same as the second sequence.

3. The radio device of claim 1, wherein the radio device is a Bluetooth Low Energy device.

4. The radio device of claim 1, wherein at least some of the radio packets transmitted in the transmitting mode are pointer packets which point to a payload radio channel.

5. The radio device of claim 1, wherein the radio device, upon receiving at least one pointer packet which points to a payload radio channel, is configured to listen to the payload radio channel.

6. The radio device of claim 1, wherein the plurality of radio channels comprises radio channels 37, 38, and 39 as specified in the Bluetooth Low Energy protocol.

7. The radio device claim 1, wherein the radio device is arranged to transmit on a subsequence of the second sequence while in the transmitting mode, wherein the subsequence comprises one or more of the plurality of radio channels.

8. The radio device of claim 7, wherein the transmitting on the subsequence of the second sequence is based on local radio conditions.

9. The radio device of claim 1, wherein the second sequence is repeated in the transmitting mode by cycling through the radio channels of the second sequence for a set number of times.

10. The radio device of claim 1, wherein the listening on the first radio channel at the first time has a longer duration than the transmitting on the first radio channel at the second time.

11. The radio device of claim 1, further configured to:
store an identity of the first radio channel before switching from the receiving mode to the transmitting mode; and
read the identity when switching from the receiving mode to the transmitting mode.

12. The radio device of claim 1, further configured:
at a third time, to transmit on a second radio channel of the plurality of radio channels;
when transmitting on the second radio channel, to switch from the transmitting mode to the receiving mode;
to begin to operate in the receiving mode at a fourth time on the second radio channel; and
to continue to listen for radio packets in the receiving mode according to the first sequence by sequentially listening on the radio channels of the first sequence following the second radio channel.

13. The radio device of claim 12, further configured:
to continue to listen for a plurality of radio packets in the receiving mode according to the first sequence by sequentially listening on the radio channels of the first sequence following the second radio channel, prior to reverting to the transmitting mode.

14. The radio device of claim 1, further comprising a timer which causes the switching between the receiving mode and the transmitting modes to occur at set intervals of time.

15. The radio device of claim 1, further configured:
to determine local radio traffic conditions; and
switch from the receiving mode to the transmitting mode based on the determined local radio traffic conditions.

16. The radio device of claim 1, further configured:
to receive a radio packet while listening on the first radio channel in the receiving mode; and
in response, to switch from the receiving mode to the transmitting mode.

17. The radio device of claim 1, further configured:
to continue to transmit a plurality of radio packets in the transmitting mode according to the second sequence by sequentially transmitting on the radio channels of the second sequence following the first radio channel, prior to reverting to the receiving mode.

18. A method of operating a radio device, wherein the radio device is configured:
in a receiving mode, to listen for radio packets sequentially on a plurality of radio channels according to a first sequence of the plurality of radio channels;
in a transmitting mode, to transmit radio packets sequentially on the plurality of radio channels according to a second sequence of the plurality of radio channels;
wherein the method comprises the radio device:
at a first time, listening in the receiving mode on a first radio channel of the plurality of radio channels;
when listening on the first radio channel, switching from the receiving mode to the transmitting mode;
at a second time, beginning to transmit radio packets on the first radio channel; and
continuing to transmit radio packets in the transmitting mode according to the second sequence by sequentially transmitting on the radio channels of the second sequence following the first radio channel.

19. A non-transitory computer readable storage medium comprising instructions which, when executed, cause a radio device to carry out the method according to claim 18.
